(19) United States
(12) Patent Application Publication
(10) Pub. No.: US 2025/0145847 A1
(43) Pub. Date: May 8, 2025

(54) SEALANT AND AUTOMOTIVE SEALANT

(71) Applicant: HONDA MOTOR CO., LTD., Tokyo (JP)

(72) Inventors: Yuta Yasuyoshi, Wako-shi (JP); Masuo Kondo, Wako-shi (JP); Hiroki Matsunaga, Wako-shi (JP); Tatsumasa Hidaka, Wako-shi (JP); Daisuke Nakagawa, Wako-shi (JP)

(21) Appl. No.: 18/820,334

(22) Filed: Aug. 30, 2024

(30) Foreign Application Priority Data
Nov. 6, 2023 (JP) 2023-189378

(51) Int. Cl. C09D 127/06; C09D 7/65

(52) U.S. Cl. CPC C09D 127/06; C09D 7/65

(57) ABSTRACT

The object of the present application is to improve the absorption rate of a plasticizer into the voids between the molecular chains of polyvinyl chloride and to lower the absorption start temperature of a plasticizer into the voids between the molecular chains of polyvinyl chloride. The present invention provides a sealant containing a plastisol composition, wherein the plastisol composition contains a resin composition and a plasticizer A, wherein the resin composition is a polymer alloy containing polyvinyl chloride, a modifying resin, and a plasticizer B, and wherein the plasticizer B is the same type of plasticizer as the plasticizer A, or a different type of plasticizer from the plasticizer A.

### CROSS-REFERENCE TO RELATED APPLICATION

Priority is claimed on Japanese Patent Application No. 2023-189378, filed Nov. 6, 2023, the contents of which are incorporated herein by reference.

### TECHNICAL FIELD

The present invention relates to a sealant and an automotive sealant.

### BACKGROUND ART

Conventionally, an automotive sealant is made by heating a pasty material (plastisol composition) containing inexpensive polyvinyl chloride (PVC) and an oily plasticizer at high temperatures in a drying oven to expand the distance between the PVC molecular chains, thereby making the PVC and the plasticizer compatible. However, from the perspective of environmental protection, there is a need to develop a sealant that can reduce carbon dioxide emissions by lowering the temperature of the drying oven (lowering the temperature at which the sealant gels) and reducing energy consumption.

As a sealant that gels at low temperatures, a plastisol composition produced by adding a plasticizer to an acrylic polymer having a polar group is known (see, for example, Patent Document 1).

### PRIOR ART DOCUMENTS

### Patent Documents

Patent Document 1 PCT International Publication No. WO 2013/077293

### SUMMARY OF INVENTION

### Problem to be Solved by the Invention

The plastisol composition disclosed in Patent Document 1 has a special multi-layer structure, and therefore there are problems with lowering the temperature in the drying process and suppressing the absorption of plasticizer during storage.

In order to solve the above problems, the present application aims to improve the absorption rate of a plasticizer into the voids between the molecular chains of polyvinyl chloride and to lower the absorption start temperature of a plasticizer into the voids between the molecular chains of polyvinyl chloride.

### Means for Solving the Problem

[1] A sealant containing a plastisol composition,

wherein the plastisol composition contains a resin composition and a plasticizer A,

wherein the resin composition is a polymer alloy containing polyvinyl chloride, a modifying resin, and a plasticizer B, and

wherein the plasticizer B is the same type of plasticizer as the plasticizer A, or a different type of plasticizer from the plasticizer A.

In other words, in the sealant according to the present invention, an additional plasticizer A is added to a resin composition which is a polymer alloy containing polyvinyl chloride, a modifying resin, and a plasticizer B. The plasticizer B may be the same type of plasticizer as the plasticizer A, or a different type of plasticizer from the plasticizer A.

In the sealant of the present invention, the modifying resin and the plasticizer B are made compatible with polyvinyl chloride to produce a resin composition. This weakens the intermolecular interactions of polyvinyl chloride and expands the distance between the polyvinyl chloride molecular chains. Thereby, the plasticizer is easily absorbed between the molecular chains of polyvinyl chloride even at low temperatures. Furthermore, by blending a modifying resin having a low activation temperature for molecular motion, it is possible to improve the absorption rate of the plasticizer into the voids between the molecular chains of polyvinyl chloride and lower the temperature at which the plasticizer starts to be absorbed.

Furthermore, in the resin composition, the plasticizer is absorbed between the molecular chains of polyvinyl chloride, and the plasticizer is present between the molecules of polyvinyl chloride, and the plasticizer absorption reaction is in a chemical equilibrium state. Since the swelling reaction of the plasticizer to polyvinyl chloride is not promoted at room temperature and gelation does not occur even when stored for a long period of time, the sealant has excellent storage properties when used industrially.

[2] The sealant according to [1], wherein the modifying resin is a resin having a polyolefin skeleton.

In the sealant of the present invention, when polyvinyl chloride is made compatible with a resin having a polyolefin skeleton as a modifying resin, the intermolecular interaction of polyvinyl chloride is weakened, and therefore the absorption temperature of the plasticizer can be appropriately adjusted in a wide range from 60° C. to 120° C., and the heating time can be shortened (5 to 10 minutes).

[3] The sealant according to [1] or [2], wherein the content of the modifying resin relative to 100 parts by mass of the total of the polyvinyl chloride and the modifying resin is 5 parts by mass or more and 80 parts by mass or less.

In the sealant of the present invention, the content of the modifying resin is adjusted to 5 to 80 parts by mass relative to 100 parts by mass of the total of polyvinyl chloride and the modifying resin. Thereby, it is possible to change the intermolecular interactions of polyvinyl chloride and appropriately adjust the absorption temperature of the plasticizer into polyvinyl chloride.

[4] An automotive sealant containing the sealant according to any one of [1] to [3].

5 The automotive sealant of the present invention contains a plastisol composition obtained by heating a plasticizer in a wide range from 60° C. to 120° C. This allows the heating temperature to be lowered and the heating time to be shortened when gelling a sealant used in, for example, joints between steel sheets for automobiles. This allows for a reduction in the amount of carbon dioxide emitted and the energy used when forming a coating film made of the sealant.

### Effects of the Invention

According to the present invention, it is possible to improve the absorption rate of the plasticizer into the voids between the molecular chains of polyvinyl chloride and to lower the absorption start temperature of the plasticizer into the voids between the molecular chains of polyvinyl chloride.

### DETAILED DESCRIPTION OF THE PREFERRED EMBODIMENTS

Hereinafter, embodiments of the present invention will be described in detail.

### [Sealant]

A sealant according to one embodiment of the present invention is a sealant containing a plastisol composition.

In the sealant of the present embodiment, the plastisol composition contains a resin composition and a plasticizer A. The resin composition is a polymer alloy containing polyvinyl chloride, a modifying resin, and a plasticizer B. The plasticizer B is the same type of plasticizer as the plasticizer A, or a different type of plasticizer from the plasticizer A.

### [Plastisol Composition]

Examples of the plasticizer A include phthalate ester plasticizers such as dimethyl phthalate, diethyl phthalate, dibutyl phthalate, diheptyl phthalate, di-2-ethylhexyl phthalate, dioctyl phthalate, diisononyl phthalate, diisodecyl phthalate, and butyl benzyl phthalate; adipate ester plasticizers such as dimethyl adipate, dibutyl adipate, diisobutyl adipate, dihexyl adipate, di-2-ethylhexyl adipate, diisononyl adipate, and dibutyl diglycol adipate; phosphate ester plasticizers such as trimethyl phosphate, triethyl phosphate, tributyl phosphate, tri-2-ethylhexyl phosphate, tributoxyethyl phosphate, triphenyl phosphate, tricresyl phosphate, trixylenyl phosphate, and cresylphenyl phosphate; trimellitate ester plasticizers such as tri-2-ethylhexyl trimellitate; sebacate ester plasticizers such as dimethyl sebacate, dibutyl sebacate, and di-2-ethylhexyl sebacate; aliphatic polyester plasticizers such as poly-1,3-butanediol adipate; benzoate plasticizers such as diethylene glycol dibenzoate and dibutylene glycol dibenzoate; epoxidized ester plasticizers such as epoxidized soybean oil; alkylsulfonic phenyl ester plasticizers such as alkylsulfonic phenyl ester; alicyclic dibasic ester plasticizers; polyether plasticizers such as polypropylene glycol and polybutylene glycol; and citric acid plasticizers such as acetyl tributyl citrate. These plasticizers may be used alone or in combination of two or more. Among these, from the viewpoints of price and availability, it is preferable to use one or more of dioctyl phthalate, diisononyl phthalate, diisodecyl phthalate, alkyl phenyl sulfate, and acetyl tributyl citrate as the main component.

The content of the plasticizer A relative to the total mass (100% by mass) of the plastisol composition is preferably 5% by mass or more and 60% by mass or less, more preferably 10% by mass or more and 40% by mass or less, and even more preferably 15% by mass or more and 30% by mass or less. When the content of the plasticizer A is equal to or more than the lower limit, the gelation of the resin composition proceeds sufficiently, and the mechanical elongation of the plastigel composition after the plasticizer is absorbed can be improved. When the content of the plasticizer A is equal to or less than the upper limit, the amount of plasticizer absorbed by the resin is not excessive, and sufficient mechanical strength can be ensured.

In addition to the resin composition and the plasticizer A, the plastisol composition may contain, as necessary, a filler, an adhesive, a pigment, a diluent, an antifoaming agent, an antifungal agent, a leveling agent, and the like.

Examples of the filler include calcium carbonate, aluminum hydroxide, colloidal silica, talc, glass powder, and aluminum oxide. The content of the filler in the plastisol composition can be appropriately selected depending on the purpose.

The adhesive can be appropriately selected depending on the type of substrate to which the sealant is applied. Examples of the adhesives include epoxy resin adhesives, block urethane resin adhesives, and polyamine adhesives. These may be used alone or in combination of two or more. Furthermore, a hardener for the adhesive can also be used. For example, hardeners such as acid anhydrides and imidazole compounds can be used for epoxy resin adhesives, and hardeners such as dihydrazide compounds can be used for block urethane resin adhesives.

Examples of the pigments include titanium oxide and carbon black.

Examples of the diluents include mineral turpentine and mineral spirits.

The content of the resin composition relative to the total mass (100 mass %) of the plastisol composition is preferably 5 mass % or more and 50 mass % or less, more preferably 10 mass % or more and 40 mass % or less, and even more preferably 15 mass % or more and 30 mass % or less. When the content of the resin composition is equal to or more than the lower limit, the mechanical elongation of the plastisol composition itself can be ensured by the contribution of the resin component. When the content of the resin composition is equal to or less than the upper limit, the mechanical strength of the sealant can be improved and the cost can be reduced by blending additives such as fillers.

The plastisol composition can be prepared, for example, by dispersing the resin composition in the plasticizer A. A known mixer can be used to disperse the resin composition in the plasticizer A. Examples of the mixer include a Pony mixer, a Change-can mixer, a Hobart mixer, a planetary mixer, a butterfly mixer, a mortar mixer, and a kneader.

### [Resin Composition]

As the polyvinyl chloride, polyvinyl chloride homopolymer is preferably used.

The content of polyvinyl chloride relative to the total mass (100 mass %) of the resin composition is preferably 20% by mass or more and 70% by mass or less, more preferably 30% by mass or more and 60% by mass or less, and even more preferably 40% by mass or more and 50% by mass or less. When the content of polyvinyl chloride is equal to or more than the lower limit, flame retardancy and mechanical strength can be ensured, and since polyvinyl chloride is inexpensive, the manufacturing cost of the plastisol composition can be reduced. When the content of polyvinyl chloride is equal to or less than the upper limit, the ratio of the modifying resin can be increased, and therefore the absorption start temperature of the plasticizer can be lowered.

As the modifying resin, for example, a resin having a polyolefin skeleton, a resin having a solubility parameter close to that of polyvinyl chloride, and the like may be used. Among these, a resin having a polyolefin skeleton is preferred.

Examples of the resin having a polyolefin skeleton include ethylene-vinyl acetate copolymer (EVA), ethylene-ethyl acrylate copolymer (EEA), chlorinated polyethylene (CPE), thermoplastic polyamide (PA), acid-modified polyethylene, and thermoplastic elastomer (TPO). These resins are modifying resins with low activation onset temperatures for molecular motion.

The content of the modifying resin relative to the total mass (100 mass %) of the resin composition is preferably 10% by mass or more and 40% by mass or less, more preferably 15% by mass or more and 30% by mass or less, and even more preferably 20% by mass or more and 25% by mass or less. When the content of the modifying resin is equal to or more than the lower limit, the absorption start temperature of the plasticizer can be lowered. When the content of the modifying resin is equal to or less than the upper limit, the flame retardancy and mechanical strength derived from the characteristics of polyvinyl chloride can be secured, and since polyvinyl chloride is inexpensive, the cost of the plastisol composition can be reduced.

The content of the modifying resin relative to 100 parts by mass of the total of polyvinyl chloride and the modifying resin is preferably 5 parts by mass or more and 80 parts by mass or less, more preferably 10 parts by mass or more and 50 parts by mass or less, and even more preferably 20 parts by mass or more and 40 parts by mass or less. When the content of the modifying resin relative to 100 parts by mass of the total of polyvinyl chloride and the modifying resin is equal to or more than the lower limit, the activation of molecular motion by the modifying resin becomes prominent, so that the absorption start temperature of the plasticizer can be lowered. When the content of the modifying resin relative to 100 parts by mass of the total of polyvinyl chloride and the modifying resin is equal to or less than the upper limit, the flame retardancy and mechanical strength derived from the characteristics of polyvinyl chloride can be secured, and since polyvinyl chloride is inexpensive, the cost of the plastisol composition can be reduced.

As the plasticizer B, the same one as the plasticizer A is used.

The plasticizer B may be the same type of plasticizer as the plasticizer A, or may be a different type of plasticizer from the plasticizer A. When the plasticizer B is a different type of plasticizer from the plasticizer A, preferred combinations of the plasticizer A and plasticizer B include, for example, a combination in which the plasticizer A is diisononyl phthalate and the plasticizer B is tri-normal alkyl trimellitate, a combination in which the plasticizer A is diisononyl phthalate and the plasticizer B is di-2-ethylhexyl phthalate, and a combination in which the plasticizer A is diisononyl phthalate and the plasticizer B is bis (2-ethylhexyl) 4-cyclohexene-1,2-dicarboxylate.

The content of the plasticizer B relative to the total mass (100% by mass) of the resin composition is preferably 5% by mass or more and 60% by mass or less, more preferably 15% by mass or more and 50% by mass or less, and even more preferably 20% by mass or more and 40% by mass or less. When the content of the plasticizer B is equal to or more than the lower limit, the powdered polyvinyl chloride is consolidated, making it possible to mold in the mixing step and the granulation step. When the content of the plasticizer B is equal to or less than the upper limit, the plasticizer absorption amount of the resin composition is not saturated (a margin can be left in the absorption amount), so that the plasticizer can be sufficiently absorbed in the subsequent steps.

The ratio of the plasticizer B to the plasticizer A (plasticizer B/plasticizer A) is preferably 0.05 or more and 0.5 or less, more preferably 0.1 or more and 0.4 or less, and even more preferably 0.2 or more and 0.3 or less, in mass ratio. When the ratio is equal to or more than the lower limit, the plasticizer is sufficiently contained between the molecules of the resin component, thereby improving storage stability. When the ratio is equal to or less than the upper limit, the plasticizer absorption amount of the resin composition is not saturated (a margin can be left in the absorption amount), so that the plasticizer can be sufficiently absorbed in the subsequent steps.

The sealant of the present embodiment can improve the absorption rate of the plasticizer into the voids between the molecular chains of polyvinyl chloride, and can also lower the temperature at which the plasticizer starts to be absorbed into the voids between the molecular chains of polyvinyl chloride.

### [Production Method of Sealant]

The production method of a sealant of the present embodiment includes a step of preparing a resin composition containing polyvinyl chloride, the modifying resin, and the plasticizer B (hereinafter referred to as the “first step”), and a step of preparing a plastisol composition containing the resin composition and the plasticizer A (hereinafter referred to as the “second step”).

In the first step, polyvinyl chloride, the modifying resin, and the plasticizer B are mixed in a predetermined ratio, kneaded, and then granulated (pulverized) to produce a polymer alloy (resin composition) containing polyvinyl chloride, the modifying resin, and the plasticizer B.

In the kneading method, for example, a twin screw extrusion kneader, a single screw extrusion kneader, a Banbury mixer, a pressure kneader, or the like can be used. Furthermore, in a granulation method, a powder mill (fine grinding machine), an impact grinding machine, a stamp grinding machine, or the like can be used.

The temperature during kneading is preferably 60° C. or higher and 160° C. or lower, and more preferably 100° C. or higher and 150° C. or lower. When the temperature is equal to or higher than the lower limit, the fluidity of the resin increases, and each material can be uniformly dispersed. When the temperature is equal to or lower than the upper limit, the thermal decomposition of polyvinyl chloride is suppressed, and molding can be performed without impairing the properties of the resin composition.

The temperature during granulation is preferably 0° C. or higher and 100° C. or lower, and more preferably 10° C. or higher and 60° C. or lower. When the temperature is equal to or higher than the lower limit, the impact resistance of the resin composition can be ensured, and uniform particle size can be easily obtained. When the temperature is equal to or lower than the upper limit, softening of the resin composition is suppressed, and therefore residue in the equipment is suppressed, and thus manufacturability can be improved.

The time during kneading is preferably 3 minutes or more and 15 minutes or less, and more preferably 5 minutes or more and 10 minutes or less. When the time is equal to or more than the lower limit, sufficient mixing time can be obtained to uniformly disperse each material can be. When the time is equal to or less than the upper limit, it is possible to prevent the material from overheating and inhibit the thermal decomposition of polyvinyl chloride.

The time during granulation (pulverization) is preferably 20 minutes or more and 180 minutes or less, and more preferably 60 minutes or more and 120 minutes or less. When the time is equal to or more than the lower limit, sufficient granulation (pulverization) time can be obtained to obtain a uniform particle size. When the time is equal to or less than the upper limit, heat generation of the material due to shearing can be prevented, and therefore, residue in the equipment can be suppressed, and thus manufacturability can be improved.

In the second step, the plasticizer A and various additives are mixed in a predetermined ratio with the resin composition obtained in the first step, and the mixture is stirred to prepare the plastisol composition.

In the stirring method, for example, a planetary mixer, a pony mixer, a twin-shaft mixer, a butterfly mixer, or the like can be used.

The temperature during stirring is preferably 0° C. or higher and 40° C. or lower, and more preferably 10° C. or higher and 30° C. or lower. When the temperature is equal to or higher than the lower limit, the viscosity during stirring is reduced, enabling stable stirring. When the temperature is equal to or lower than the upper limit, absorption of the plasticizer A by the resin composition during stirring can be suppressed.

The time during stirring is preferably 5 minutes or more and 180 minutes or less, and more preferably 60 minutes or more and 120 minutes or less. When the time is equal to or more than the lower limit, the resin composition and the plasticizer are sufficiently stirred, so that the materials can be uniformly dispersed. When the time is equal to or less than the upper limit, the accumulation of shear heat generated during stirring is suppressed, so that the absorption of the plasticizer A by the resin composition can be suppressed.

Through the steps above, the sealant of the present embodiment is obtained.

In the production method of the sealant according to the present embodiment, in the first step, the modifying resin and the plasticizer B are made compatible with polyvinyl chloride to form a resin composition, thereby weakening the intermolecular interaction of polyvinyl chloride and expanding the distance between the molecular chains of polyvinyl chloride. This makes it easier for the plasticizer to be absorbed between the molecular chains of polyvinyl chloride even at low temperatures. In addition, by blending a modifying resin having a low activation temperature of molecular motion, the absorption rate of the plasticizer into the voids between the molecular chains of polyvinyl chloride can be improved and the absorption start temperature of the plasticizer can be lowered. At the time when the first step is completed, the resin composition (polymer alloy) is absorbed the plasticizer B between the molecular chains of polyvinyl chloride, the plasticizer B is present between the molecules of polyvinyl chloride, and the plasticizer absorption reaction is in a chemical equilibrium state, so that the swelling reaction with the plasticizer is not promoted at room temperature. Therefore, the obtained sealant is not easily gelled even when stored for a long period of time, and therefore has excellent storage properties when used industrially.

In the second step of the production method of the sealant according to the present embodiment, the swelling reaction between polyvinyl chloride and the plasticizer A is promoted by blending plasticizer A with the resin composition, making it possible to gel the sealant at a lower temperature than before.

### [Automotive Sealant]

The automotive sealant according to one embodiment of the present invention contains the sealant of the embodiment above.

According to the automotive sealant of the present embodiment, the heating temperature and heating time required for gelling the sealant used in the joints of automotive steel sheets can be lowered, thereby reducing the amount of carbon dioxide emitted and the energy used when forming a coating film made of the sealant.

### INDUSTRIAL APPLICABILITY

The sealant of the present invention does not promote a swelling reaction with a plasticizer at room temperature and is unlikely to absorb a plasticizer even during long-term storage, and therefore has excellent storage properties when used industrially, and therefore has industrial applicability.

What is claimed is:

1. A sealant containing a plastisol composition,
wherein the plastisol composition comprises a resin composition and a plasticizer A,
wherein the resin composition is a polymer alloy containing polyvinyl chloride, a modifying resin, and a plasticizer B, and
wherein the plasticizer B is the same type of plasticizer as the plasticizer A, or a different type of plasticizer from the plasticizer A.

2. The sealant according to claim 1, wherein the modifying resin is a resin having a polyolefin skeleton.

3. The sealant according to claim 1, wherein the content of the modifying resin relative to 100 parts by mass of the total of the polyvinyl chloride and the modifying resin is 5 parts by mass or more and 80 parts by mass or less.

4. The sealant according to claim 2, wherein the content of the modifying resin relative to 100 parts by mass of the total of the polyvinyl chloride and the modifying resin is 5 parts by mass or more and 80 parts by mass or less.

5. An automotive sealant containing the sealant according to claim 1.

6. An automotive sealant containing the sealant according to claim 2.

7. An automotive sealant containing the sealant according to claim 3.
